(19) United States
(12) Patent Application Publication
(10) Pub. No.: US 2019/0335318 A1
(43) Pub. Date: Oct. 31, 2019

(54) Mobile Virtual Network Operator International Roaming Device, System, and Process

(71) Applicant: TracFone Wireless, Inc., Miami, FL (US)

(72) Inventor: Theodore Vagelos, Miami, FL (US)

(21) Appl. No.: 16/398,884

(22) Filed: Apr. 30, 2019

Related U.S. Application Data
(60) Provisional application No. 62/664,461, filed on Apr. 30, 2018.

(51) Int. Cl. H04W 8/12; H04W 8/18; H04W 8/20; H04W 8/24

(52) U.S. Cl. CPC H04W 8/12; H04W 8/183; H04W 4/24; H04W 8/24; H04W 8/205

(57) ABSTRACT

A method for international roaming includes storing in a non-transitory memory an international roaming application, configuring a SIM (Subscriber Identity Module) to store identification information for accessing a first wireless network, configuring a Soft SIM stored in the non-transitory memory to store identification information for accessing a second wireless network, displaying on a display a user interface having a prompt to input information in response to the international roaming application, wirelessly communicating with a transceiver with the first wireless network and the second wireless network, executing with a processor, operatively coupled to the memory and the display, the international roaming application, and implementing with the processor either the SIM in response to the international roaming application to access the first wireless network or the Soft SIM in response to the international roaming application to access the second wireless network.

### CROSS-REFERENCE TO RELATED APPLICATIONS

This application claims the benefit from U.S. Provisional Application No. 62/664,461 filed on Apr. 30, 2018, which is hereby incorporated by reference in its entirety for all purposes as if fully set forth herein.

### BACKGROUND OF THE DISCLOSURE

### 1. Field of the Disclosure

The disclosure generally relates to processes and applications for providing international roaming on wireless devices. Moreover, the disclosure generally relates to devices, systems and applications for providing international roaming on wireless devices.

### 2. Related Art

Currently most Mobile Virtual Network Operators (MVNO) or pre-paid mobile phone providers do not permit international roaming due to the high cost of roaming and the lack of real-time data regarding mobile phone usage to, for example, limit calls, SMS messages, data and the like. Accordingly, MVNO mobile phone users that travel outside of their home country do not even consider using a prepaid phone provided by the MVNO because their mobile phones do not work outside of their home country.

Additionally, many Mobile Network Operators (MNO) or postpaid mobile phone providers charge exorbitant amounts to roam internationally. This results in many MNO mobile phone users being very hesitant to roam internationally resulting in great inconvenience.

Accordingly, a need exists in the art for innovative processes, systems, devices, and applications to provide convenient lower cost international roaming to wireless device users and help improve user experience.

### SUMMARY OF THE DISCLOSURE

The foregoing needs are met, to a great extent, by the disclosure, with a process, system, device and application for lower cost convenient international roaming with a wireless device.

One aspect of the disclosure is directed to a method for international roaming that includes storing in a non-transitory memory an international roaming application, configuring a SIM (Subscriber Identity Module) to store identification information for accessing a first wireless network, configuring a Soft SIM stored in the non-transitory memory to store identification information for accessing a second wireless network, displaying on a display a user interface having a prompt to input information in response to the international roaming application, wirelessly communicating with a transceiver with the first wireless network and the second wireless network, executing with a processor, operatively coupled to the memory and the display, the international roaming application, and implementing with the processor either the SIM in response to the international roaming application to access the first wireless network or the Soft SIM in response to the international roaming application to access the second wireless network.

Another aspect of the disclosure is directed to a system a wireless device configured to provide international roaming capability that includes a non-transitory memory configured to store instructions to implement an international roaming application, a SIM (Subscriber Identity Module) configured to store identification information for accessing a first wireless network, a Soft SIM stored in the non-transitory memory, the Soft SIM configured to store identification information for accessing a second wireless network, a display configured to display a user interface having a prompt to input information in response to the international roaming application, a transceiver configured to wirelessly communicate with the first wireless network and the second wireless network, a processor, operatively coupled to the memory and the display, the processor configured to execute the international roaming application, and the processor further configured to implement either the SIM in response to the international roaming application to access the first wireless network or the Soft SIM in response to the international roaming application to access the second wireless network.

There has thus been outlined, rather broadly, certain aspects of the disclosure in order that the detailed description thereof herein may be better understood, and in order that the present contribution to the art may be better appreciated. There are, of course, additional aspects of the disclosure that will be described below and which will form the subject matter of the claims appended hereto.

In this respect, before explaining at least one aspect of the disclosure in detail, it is to be understood that the disclosure is not limited in its application to the details of construction and to the arrangements of the components set forth in the following description or illustrated in the drawings. The disclosure is capable of aspects or aspects in addition to those described and of being practiced and carried out in various ways. Also, it is to be understood that the phraseology and terminology employed herein, as well as the abstract, are for the purpose of description and should not be regarded as limiting.

Reference in this application to “one aspect,” “an aspect,” “one or more aspects,” “an aspect” or the like means that a particular feature, structure, or characteristic described in connection with the aspect is included in at least one aspect of the disclosure. The appearances of, for example, the phrases “an aspect” in various places in the specification are not necessarily all referring to the same aspect, nor are separate or alternative aspects mutually exclusive of other aspects. Moreover, various features are described which may be exhibited by some aspects and not by the other. Similarly, various requirements are described which may be requirements for some aspects but not by other aspects.

As such, those skilled in the art will appreciate that the conception upon which this disclosure is based may readily be utilized as a basis for the designing of other structures, methods and systems for carrying out the several purposes of the disclosure. It is important, therefore, that the claims be regarded as including such equivalent constructions insofar as they do not depart from the spirit and scope of the disclosure.

### BRIEF DESCRIPTION OF THE DRAWINGS

In order to facilitate a fuller understanding of the disclosure, reference is now made to the accompanying drawings, in which like elements are referenced with like numerals. These drawings should not be construed as limiting the disclosure and intended only to be illustrative.

FIG. 1 illustrates a wireless device in accordance with an aspect of the disclosure.

FIG. 2 illustrates an interface screen of a wireless device in accordance with an aspect of the disclosure.

FIG. 3 illustrates a wireless device process in accordance with an aspect of the disclosure.

FIG. 4 illustrates a wireless device system in accordance with an aspect of the disclosure.

FIG. 5 illustrates a wireless device system process in accordance with an aspect of the disclosure.

FIG. 6 illustrates a further wireless system process in accordance with an aspect of the disclosure.

### DETAILED DESCRIPTION

In today's marketplace, it would be beneficial to equip a wireless device with the tools necessary to efficiently and cost-effectively provide international roaming capability. Preferably, the international roaming capability may be accomplished on the wireless device without requiring live customer service agents. In one aspect, it would be beneficial to make implementation of international roaming relatively simple and straightforward. In one aspect, the international roaming capability may be accomplished while the service for the wireless device from the current service provider is still active. Therefore, the subscriber may maintain wireless service with their current service provider.

As described in detail below, prior to traveling internationally, a user may obtain and access an International Roaming Application (IRA) on their wireless device and select the one or more countries that they will be visiting along with the duration of their visit. Thereafter, the user may then be given a choice of prepaid plans that may subscribe to during their visit such as by the amount of wireless service or by the day, week, or month. After the user selects the plans and the days, weeks or months of service requested, they can use a credit/debit card or other form of payment to pay for the international roaming service in the IRA. After the payment has been successfully processed, the user may then be assigned a temporary cellular phone number for the International Roaming that they have purchased. Prior to departing their home country, the customer could either provide the temporary cellular phone number to their friends/family or forward their calls to the temporary cellular phone number. Once the user is in the visiting country, a soft SIM (Subscriber Identity Module) profile that is implemented by the IRA would reflect the local host MVNO and the local host MVNO would be responsible for all billing and technical support.

It is to be understood that system units and method steps described in this application may be employed in various forms of hardware, software, firmware, special purpose processors or a combination thereof. In one aspect, the application may be directed to a process and system utilizing a software application comprising executable code that is operably stored on one or more tangible non-transitory program storage devices including but not limited to a magnetic floppy disk, RAM, ROM, CD ROM and/or Flash memory.

In aspects including a “wireless network”, the network may encompass any type of wireless network from which a Mobile Virtual Network Operator (MVNO) contracts with a Mobile Network Operator (MNO) wireless carrier to provide wireless services through the use of an electronic device, such as a Long Term Evolution (LTE) network, a fifth generation (5G) network, a Global System for Mobile Communication (GSM) network, Code-Division Multiple Access (CDMA) network, a network utilizing a communication channel as defined herein or the like, that may utilize the teachings of the present application to allow a wireless device to connect to a wireless network. In other aspects, the network may include a post-paid wireless carrier or Mobile Network Operators (MNO) that maintains and controls their own wireless networks. Namely, a

MNO heavily relies on backend systems to address any provisional, billing, security and data issues that might threaten the health of their networks. In this regard, the disclosure may be implemented with a wireless device provisioned by a MNO or a MVNO. Likewise, a MNO or a MVNO may be utilized to implement the disclosure.

In one aspect of the disclosure, there is described a method for improving user experience with international roaming utilizing a wireless device. That is, international roaming capability may be initiated via an international roaming application 106 that replaces the user's 1 current wireless service provider with a local wireless service provider.

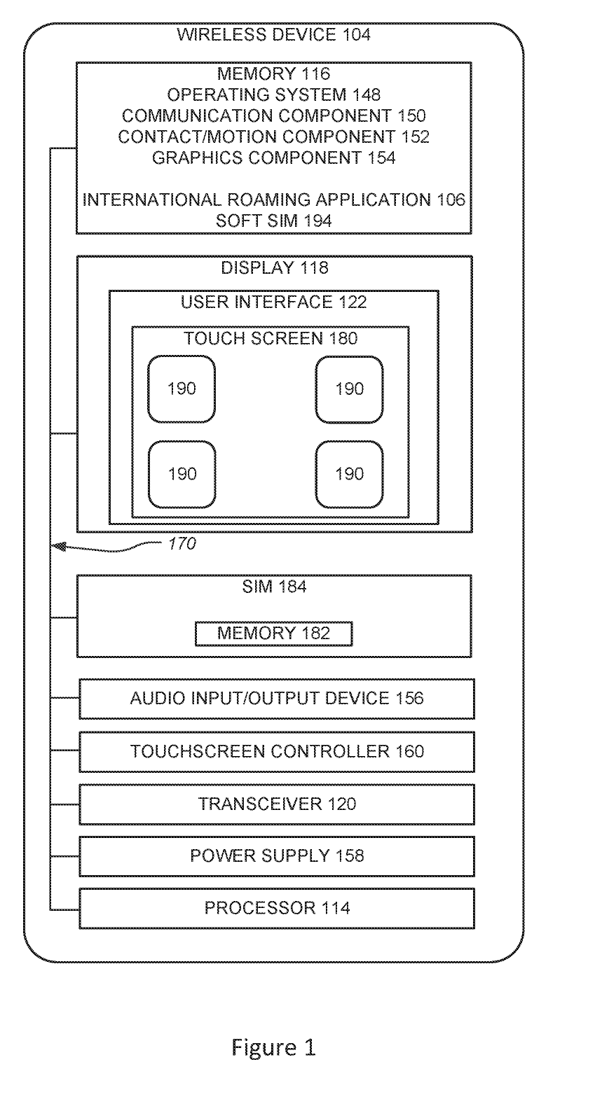

FIG. 1 illustrates a wireless device in accordance with an aspect of the disclosure. In particular, FIG. 1 illustrates a wireless device 104 that includes a memory 116. The wireless device 104 may further include an operating system 148, a communication component 150, a contact/motion component 152, a graphics component 154, and the like. The operating system 148 together with the various components provides software functionality for each of the components of the wireless device 104. The memory 116 may include a high-speed, random-access memory. Also, the memory 116 may be a non-volatile memory, such as magnetic fixed disk storage, flash memory or the like. These various components may be connected through various communication lines including a data bus 170. The memory 116 may also store device related information including but not limited to a device serial number, such as, for example, an International Mobile Equipment Identify (IMEI), an Electronic Serial Number (ESN), Mobile Equipment Identifier (MEID), and/or the like.

In another aspect of the disclosure, the memory 116 of a wireless device 104 may include a database for storing user information. The user information may include further information as required by the service provider and may include information such as full name, address, date of birth, telephone number, service provider, email address, contact number, credit card information, and the like. In one aspect, the database may include security questions. In another aspect, the database may include user specified preferences.

The wireless device 104 may also include a SIM card 184 having a memory 182. The memory 182 stores the SIM card serial number, and may be implemented as, for example, an integrated Circuit Card ID (ICCID).

The wireless device 104 also includes a processor 114 that may be a central processing unit configured to execute instructions, such as, for example, instructions related to software programs. Any processor can be used for the electronic device as understood by those of ordinary skill in the art. The processor 114 may be coupled to the user interface 122, the SIM card 184, the memory 116, and the like. In another aspect, the processor 114 is automatically capable of obtaining the serial numbers of the device and the SIM card 184. In some aspects, the processor 114 may be implemented as a microprocessor, a chipset, a system-on-a-chip (SoC), and/or the like.

In one aspect, the display 118 may be a liquid crystal display (LCD). Preferably the LCD includes a backlight to illuminate the various color liquid crystals to provide a more colorful display. In one aspect, the display 118 may be a Thin Film Transistor (TFT), an Organic Light-Emitting Diode (OLED), an Active Matrix Organic Light-Emitting Diode (AMOLED), a Passive Matrix OLED (P-OLED), or the like. The user interface 122 may be any type of physical input as readily employed in the field. For example, the user interface may have physical buttons. Alternatively, the user interface may be implemented on a touchscreen 180. Additionally, the wireless device 104 includes a power supply 158.

The wireless device 104 may include an audio input/output device 156. The audio input/output device 156 may include speakers, speaker outputs, microphones, microphone inputs, and the like, for receiving and sending sound inputs. In an exemplary aspect, the audio input/output device 156 may include an analog to digital converter and a digital to audio converter for audio input and output functions respectively.

In a further aspect, the wireless device 104 may include a transceiver 120. The wireless device 104 may provide radio and signal processing as needed to access a network for services in conjunction with the transceiver 120. The processor 114 may be configured to process call functions, data transfer, and the like and provide other services to the user.

In an exemplary aspect, the touchscreen 180 of the disclosure may be implemented in the display 118 and may detect a presence and location of a touch of a user within the display area. For example, touching the display 118 of the wireless device 104 with a finger or hand. The touchscreen 180 may also sense other passive objects, such as a stylus. The wireless device 104 may further include a touch screen controller 160.

In operation, the display 118 may show various objects 190 associated with applications for execution by the processor 114. For example, a user may touch the display 118, particularly the touchscreen 180, to interact with the objects 190. That is, touching an object 190 may execute an application in the processor 114 associated with the object 190 that is stored in memory 116. Additionally or alternatively, touching an object 190 may open a menu of options to be selected by the user. The display 118 may include a plurality of objects 190 for the user to interact with. Moreover the display 118 may include a plurality of screens. The display 118 showing one screen at a time. The user may interact with the display 118 to move a screen into view on the display 118. Various objects 190 may be located in each of the screens.

The touchscreen 180 may have different attributes. The touchscreen 180 may be implemented as a resistive touchscreen, a surface acoustic wave touch screen, a capacitive touch screen, a surface capacitance touchscreen, projected capacitive touch screen, self-capacitance sensors, infrared sensors, dispersive signal technology, acoustic pulse recognition, or the like.

The display 118 is generally configured to display a user interface 122 (a graphical user interface (GUI)) that provides an easy to use visual interface between a user of the wireless device 104 and the operating system or application(s) running on the wireless device 104. Generally, the GUI presents programs, files and operational options with graphical images. During operation, the user may select and activate various graphical images which appear on the display 118 in order to initiate functions and tasks associated therewith.

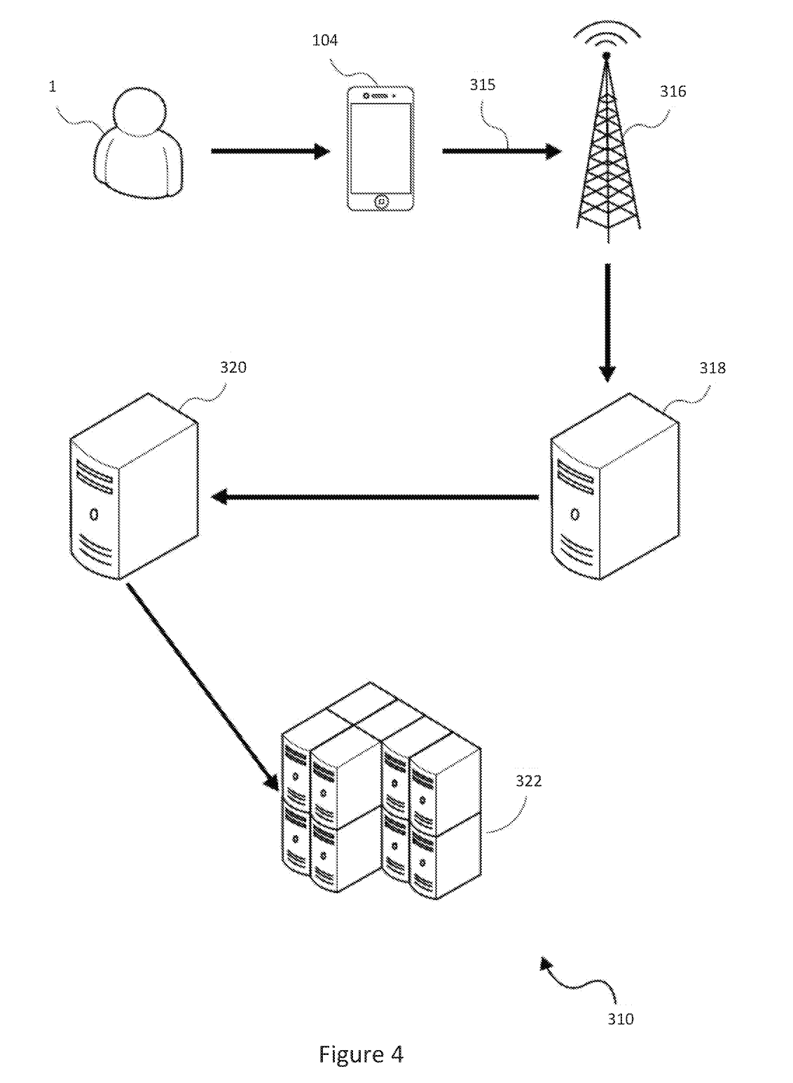

The international roaming application 106 may be executed by the processor 114. When not enabled, the international roaming application 106 takes no action and the wireless device 104 operates consistent with normal operation by providing wireless service to a user 1 over a communication channel 315 provided by a network 316 (see FIG. 4). During this normal operation, the SIM card 184 is utilized. The SIM card 184 may be an integrated circuit chip that is intended to securely store an international mobile subscriber identity (IMSI) number and its related key used to identify and authenticate user 1 along with any other additional data and information. The SIM card 184 may further contain a unique serial number (ICCID), security authentication and ciphering information, temporary information related to the local network, a list of the services the user has access, and/or the like.

The network 316 may include a Mobile services Switching Center (MSC) that may perform the switching of calls and that may include a Visitor Location Register (VLR). The network 316 may also include a Base Transceiver Station (BTS) and a Base Station Controller (BSC). The base transceiver station houses the radio transceivers that define a cell and handle the radio-link protocols with the wireless device 104. The base station controller manages the radio resources for one or more base transceiver stations. The base station controller is the connection between the wireless device 104 and the Mobile service Switching Center (MSC).

A Home Location Register (HLR) and the VLR together with the MSC, provide the call-routing and roaming capabilities. The HLR contains all the administrative information of each subscriber registered in the corresponding network 316, along with the current location of the wireless device 104. The above is an exemplary implementation of the network 316. Other types of networks utilizing other types of protocols may be implemented as well and are contemplated by the disclosure.

When the international roaming application 106 is enabled, the wireless device 104 operates to override the functionality of the SIM card 184 by providing an alternative SIM functionality to provide international roaming wireless service to the user 1 over a communication channel 315 provided by a network 316. In this regard, the alternative SIM functionality may be implemented as a soft SIM, eSim, or the like. For brevity, this alternative SIM functionality will be referred to as a Soft SIM 194. The Soft SIM 194 may be stored in the memory 116. Moreover, the Soft SIM 194 may be stored in an encrypted manner. Additionally, the Soft SIM 194 may include a soft SIM profile.

During this international roaming operation, the Soft SIM 194 is intended to securely store an international mobile subscriber identity (IMSI) number and its related key used to identify and authenticate user 1. The Soft SIM 194 may further contain a unique serial number (ICCID), security authentication and ciphering information, temporary information related to the host network, a list of the services the user has access, and the like. This information may be stored securely utilizing encryption and may form part of the soft SIM profile. The host network being the international network that is located in the country the user 1 is visiting. In one aspect, at least a portion of the information of the Soft SIM 194 is different from a portion of the information for the SIM card 184.

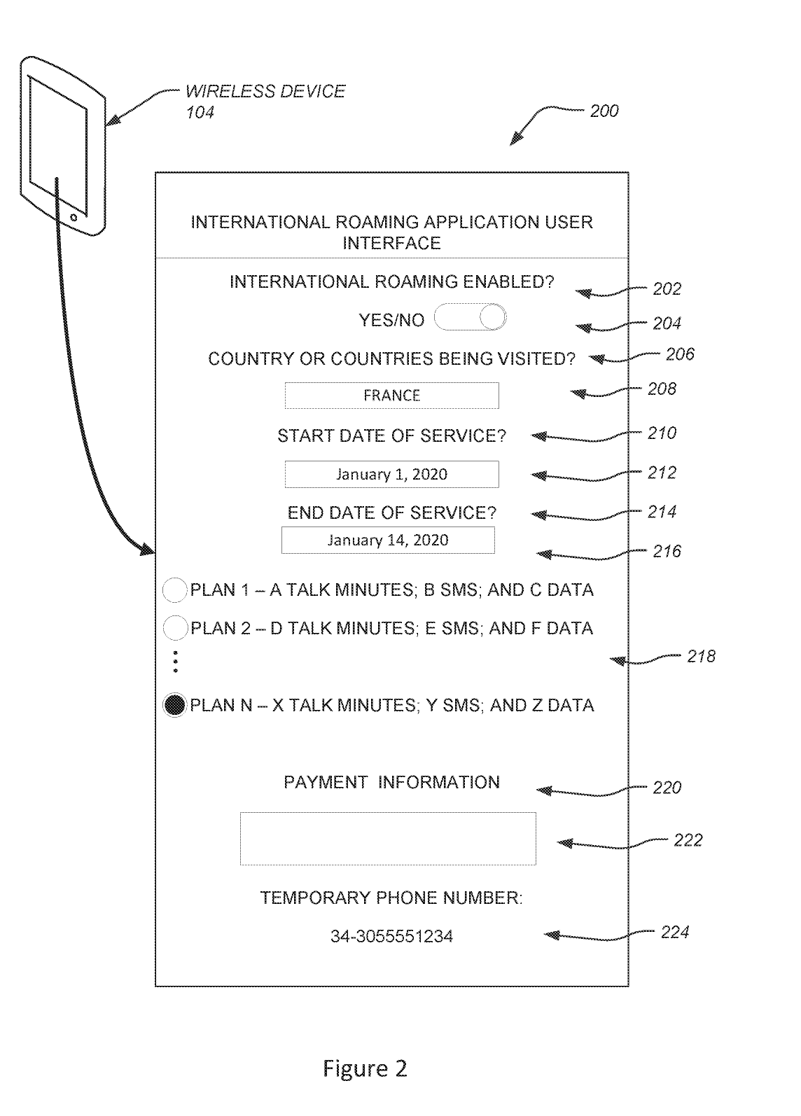

FIG. 2 illustrates an interface screen of a wireless device in accordance with an aspect of the disclosure. As shown in FIG. 2, there is illustrated an graphical user interface 200 generated by the user interface 122 of the display 118 which includes a prompt for inputting user information for purposes of international roaming. It is contemplated that the graphical user interface 200 may include additional or fewer features as needed by the particular implementation of the graphical user interface 200.

As shown in FIG. 2, the graphical user interface 200 may include a section for enabling international roaming 202. This section of the graphical user interface 200 may further include an input 204 that enables (yes) or disables (no) the international roaming application 106. Alternatively, enabling international roaming 202 may be automatic based on a location determination responsive to available wireless networks, a global navigation satellite system (GNSS) receiver location determination, and the like.

Accordingly, when the user 1 is in their home market, the user 1 disables the international roaming application 106 and the Soft SIM 194 is likewise disabled, allowing the wireless device 104 to operate in conjunction with the SIM card 184. On the other hand, when the user 1 is outside their home market traveling internationally, the user 1 enables the international roaming application 106 and the Soft SIM 194 is likewise enabled, allowing the wireless device 104 to operate in conjunction with the Soft SIM 194. Again, the enabling and the disabling may be automatic as noted above.

In section 206, the countries that will be visited by the user 1 may be input to a box 208. Other types of input functionality are contemplated as well such as drop-down lists, radio buttons, and the like. As shown in box 208, the user has input the country of France.

In section 210, the user is prompted for the start date of international service. In this regard, if a user is going to visit France on Jan. 1, 2020, they may insert that date as shown in box 212. Other types of input functionality are contemplated as well such as drop-down lists, interactive calendars, and the like.

In section 214, the user is prompted for the end date of international service. In this regard, if a user is going to leave France on Jan. 14, 2020, they may insert that date as shown in box 216. Other types of input functionality are contemplated as well such as drop-down lists, interactive calendars, and the like.

After the information has been input as noted above, the international roaming application 106 may generate one or more potential plans 218 for the user to select based on the input information. Alternatively, the one or more potential plans 218 may not need the input information to generate the one or more potential plans 218. As shown in FIG. 2, the interface 200 has generated Plan 1, Plan 2 . . . Plan N. In one aspect, each of Plan 1, Plan 2 . . . Plan N may provide a different amount of talk minutes, SMS messages, and data and may moreover provide the cost for each of these plans 218. Thereafter, a user may select one of the plans by interaction with the graphical user interface 200. The interaction with the graphical user interface 200 may include radio buttons, checkboxes, and the like. As shown in FIG. 2, the selection is shown with radio buttons with Plan N having been selected. Alternatively, the user 1 may be given choice of prepaid plans that they could subscribe to by the day, week, or month. The information provided by the user 1 defining the international roaming information.

Further shown in FIG. 2, payment information 220 may be input to the graphical user interface 200 in box 222. The box 222 may include a section to enter a credit card number, expiration date, CVN code, billing address, and the like. Alternatively, the box 222 may allow for the input of other types of billing information. Once the billing information has been confirmed, the graphical user interface 200 may generate a local temporary phone number associated with the international roaming application 106 as shown at section 224. Prior to departing their home country, the user 1 may provide the temporary cellular phone number to their friends/family or forward their calls to the temporary cellular phone number. Alternatively, the graphical user interface 200 may be implemented through a web-based interface accessible what the wireless device 104 or a PC that generates a graphical user interface to receive international roaming information, payment information, provide the temporary phone number, and the like described above with reference to FIG. 2. Alternatively, the graphical user interface 200 may be implemented through a phone call to an interactive voice response (IVR) system to receive the international roaming information, the payment information, provide the temporary phone number, and the like described above with reference to FIG. 2. Alternatively, the data provided to the graphical user interface 200 may be implemented through a voice recognition implementation of the international roaming application 106 to receive the international roaming information, the payment information, provide the temporary phone number, and the like described above with reference to FIG. 2.

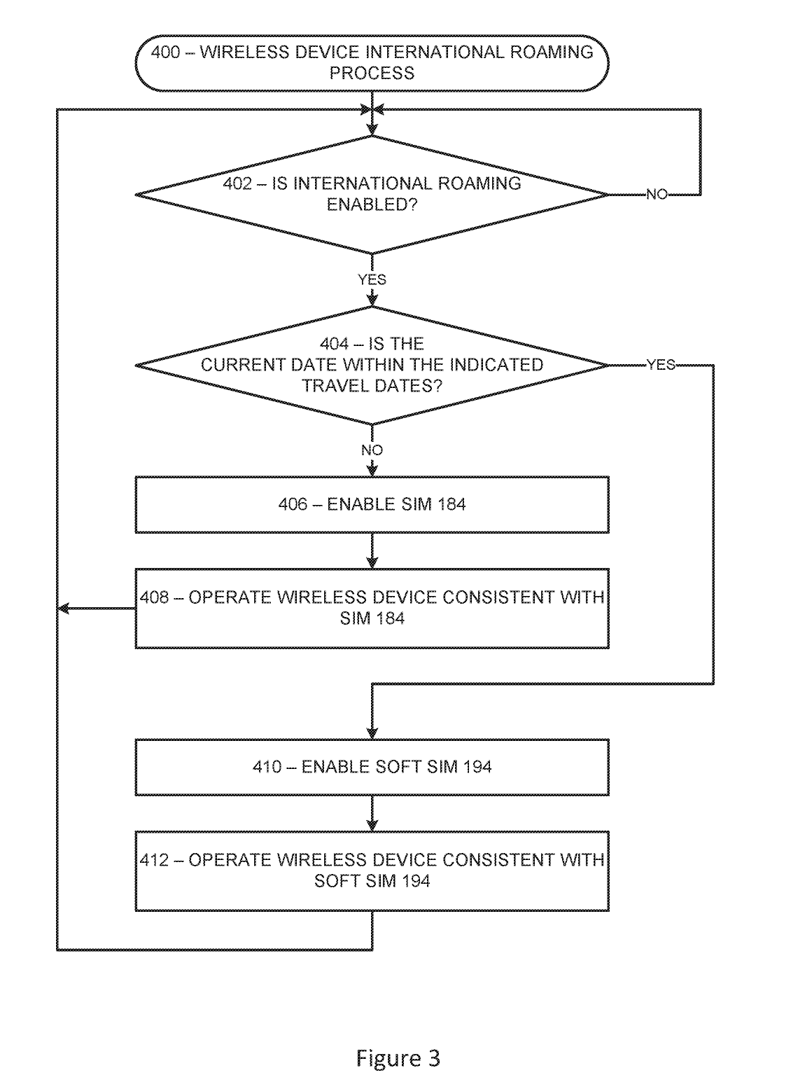

FIG. 3 illustrates a wireless device process in accordance with an aspect of the disclosure. In particular, FIG. 3 illustrates a wireless device international roaming process 400 that may be implemented by the international roaming application 106.

In box 402, the process 400 may determine whether or not international roaming enabled. If international roaming is not enabled (NO), the process will simply loop until international roaming is enabled. On the other hand, if international roaming is enabled (YES), the process will advance to box 404. The indication of whether or not international roaming is enabled or not, may be set by the user in sections 202 and 204 of the graphical user interface 200 shown in FIG. 2. Other means of determining enabled or not enabled are contemplated as well.

In box 404, the process 400 may determine whether the current date is within the indicated travel dates. The travel dates being determined from sections 210, 212, 214, and 216 of the graphical user interface 200 shown in FIG. 2. Other means of determining travel dates are contemplated as well. Alternatively, in lieu of providing travel dates, the process 400 may implement location determination through a Global Navigation Satellite System (GNSS) such as the Global Positioning System (GPS) to ascertain whether the user and the wireless device 104 are located outside the user's home market. The GNSS functionality being implemented by the processor 114 and/or transceiver 120. If the current date is within the indicated travel dates, then the process advances to box 410. If the current date is not within the indicated travel dates, then the process advances to box 406.

In box 406, the process 400 may enable the SIM card 184 and as shown in box 408, the process 400 may operate the wireless device 104 consistent with the SIM card 184 to provide wireless service to the wireless device within the user's home wireless network.

In box 410, the process 400 may enable the Soft SIM 194 and as shown in box 410, the process 400 may operate the wireless device 104 consistent with the Soft SIM 194 to provide international roaming wireless service 412 to the wireless device 104 within the host wireless network of the user's designated country. In this regard, the Soft SIM 194 would reflect the local host MVNO and the local host MVNO would be responsible for all billing and technical support.

FIG. 4 illustrates a wireless device system in accordance with an aspect of the disclosure. In one aspect, there is disclosed an international roaming system 310 as illustrated in FIG. 4. The international roaming system 310 illustrated in FIG. 4 may be implemented at least in part by the user's 1 local wireless carrier whether a MNO or a MVNO for set up of international roaming. Thereafter, when the user is traveling internationally, an equivalent international roaming system 310 as illustrated in FIG. 4 may be implemented as a host wireless carrier whether a MNO or a MVNO for providing international roaming. Alternatively, the international roaming system 310 illustrated in FIG. 4 may be implemented by a local host wireless carrier whether a MNO or a MVNO for set up of international roaming.

More specifically, international roaming system 310 may be used to set up international roaming services on the wireless device 104. The international roaming services may be activated through the international roaming system 310 to provide international roaming services for the wireless device 104 without requiring access to an agent, website, or wireless/landline telephone system.

In one aspect, a user 1 operating the wireless device 104 may execute the international roaming application 106 to initiate international roaming services. The wireless device 104 then may generate an international roaming services activation request that at least includes international roaming information input by the user 1 noted above in relation to FIG. 2 and automatically retrieve device-related information, where the activation request is transmitted over a communication channel 315 provided over a wireless carrier network 316 from the wireless device 104. The activation request may be delivered across the wireless carrier network 316 to a remote site for use in activating international roaming services on the wireless device 104.

The wireless carrier network 316 may receive the activation request via a the communication channel 315 and then forward in real time the activation request to an international roaming implementation system 322 for the activation of international roaming services for the wireless device 104. In one aspect, the international roaming implementation system 322 may be implemented by a server. In one or more aspects, the services requested to be activated include at least one an activation of international roaming wireless services of the wireless device 104 and/or purchasing of international roaming wireless services for wireless device 104. The wireless carrier network 316 may be connected to a wireless carrier system 318 that forwards the activation request to the international roaming implementation system 322, either directly or through an international roaming set up system 320 connected to the international roaming implementation system 322, to initiate international roaming service activation for the wireless device 104. The international roaming implementation system 322 and/or the international roaming set up system 320 may be further configured to process financial payments such as credit card payments, debit card payments, PayPal payments, echeck payments, electronic funds transfer payments, and the like.

Once the activation request has been approved and payment has been processed, international roaming information may be stored in the international roaming implementation system 322 for subsequent international roaming by the user 1 and their wireless device 104. Additionally, the international roaming implementation system 322 may modify a profile of the Soft SIM 194 stored on the wireless device 104 by sending information and/or data over the communication channel 315.

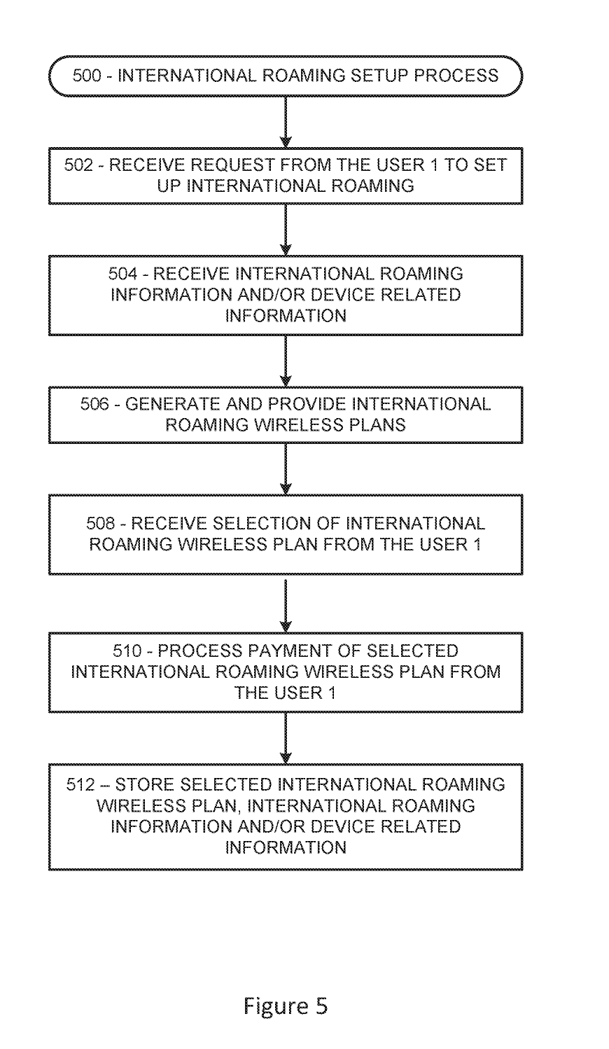

FIG. 5 illustrates a wireless device system process in accordance with an aspect of the disclosure. In particular, FIG. 5 illustrates an international roaming setup process 500 that may be implemented by the international roaming implementation system 322 or similar system.

In box 502, the international roaming implementation system 322 may receive a request from the user 1 to set up international roaming. In box 504, the international roaming implementation system 322 may receive international roaming information and/or device related information. In box 506, the international roaming implementation system 322 may generate and provide international roaming wireless plans to the wireless device 104 for display within the graphical user interface 200 of the international roaming application 106.

In box 508, the international roaming implementation system 322 may receive selection of international roaming wireless plan from the user 1. The selection may be stored in the international roaming implementation system 322. In box 510, the international roaming implementation system 322 may process payment of selected international roaming wireless plan from the user 1 from information provided within the graphical user interface 200 of the international roaming application 106. In box 512, the international roaming implementation system 322 may store the selected international roaming wireless plan, the international roaming information, the device related information, the Soft SIM 194 profile information, and/or the like.

Once the traveler is traveling internationally and operating their wireless device 104, the equivalent host wireless carrier network 316 may implement the host international roaming implementation system 322. The host international roaming implementation system 322 may recognize the Soft SIM 194 stored on the wireless device 104 and associated profile of the Soft SIM 194 stored on the wireless device 104, and provide wireless services accordingly.

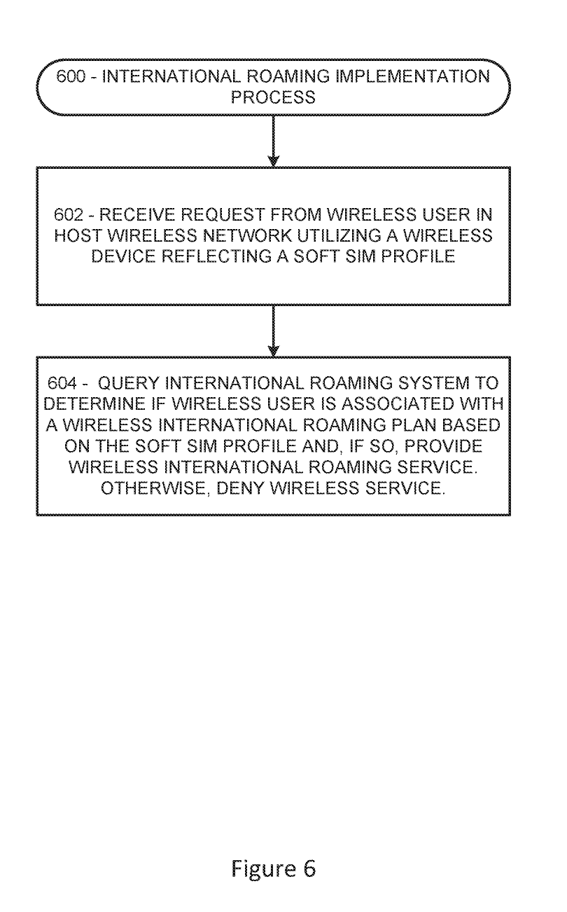

FIG. 6 illustrates a further wireless system process in accordance with an aspect of the disclosure. In particular, FIG. 6 illustrates an international roaming implementation process 600.

In box 602, the host international roaming implementation system 322 may receive request from the user in the host wireless network utilizing a wireless device reflecting a soft sim profile of the Soft SIM 194.

In box 604, the host international roaming implementation system 322 may query the international roaming system 322 to determine if the wireless user is associated with a wireless international roaming plan based on the soft SIM profile of the Soft SIM 194 and, if so, provide wireless international roaming service. otherwise, deny wireless service.

Accordingly, as described herein the disclosure includes processes, systems, devices, and applications to provide convenient lower cost international roaming to wireless device users to help improve user experience. With this solution, the host MVNOs gain more voice minutes, SMS messages, and data on their network (from International visitors); the local MVNOs have a stronger Customer Value Proposition because they can now state that they can offer International Roaming; and the customers can roam less expensively.

Aspects of the disclosure may include communication channels that may be any type of wired or wireless electronic communications network, such as, e.g., a wired/wireless local area network (LAN), a wired/wireless personal area network (PAN), a wired/wireless home area network (HAN), a wired/wireless wide area network (WAN), a campus network, a metropolitan network, an enterprise private network, a virtual private network (VPN), an internetwork, a backbone network (BBN), a global area network (GAN), the Internet, an intranet, an extranet, an overlay network, Near field communication (NFC), a cellular telephone network, a Personal Communications Service (PCS), using known protocols such as the Global System for Mobile Communications (GSM), CDMA (Code-Division Multiple Access), GSM/EDGE and UMTS/HSPA network technologies, Long Term Evolution (LTE), 5G (5th generation mobile networks or 5th generation wireless systems), WiMAX, HSPA+, W-CDMA (Wideband Code-Division Multiple Access), CDMA2000 (also known as C2K or IMT Multi-Carrier (IMT-MC)), Wireless Fidelity (Wi-Fi), Bluetooth, and/or the like, and/or a combination of two or more thereof. The NFC standards cover communications protocols and data exchange formats, and are based on existing radio-frequency identification (RFID) standards including ISO/IEC 14443 and FeliCa. The standards include ISO/IEC 18092[3] and those defined by the NFC Forum.

Aspects of the disclosure may be implemented in any type of computing devices, such as, e.g., a desktop computer, personal computer, a laptop/mobile computer, a personal data assistant (PDA), a mobile phone, a tablet computer, cloud computing device, and the like, with wired/wireless communications capabilities via the communication channels.

Aspects of the disclosure may be implemented in any type of mobile smartphones that are operated by any type of advanced mobile data processing and communication operating system, such as, e.g., an Apple™ iOS™ operating system, a Google™ Android™ operating system, a RIM™ Blackberry™ operating system, a Nokia™ Symbian™ operating system, a Microsoft™ Windows Mobile™ operating system, a Microsoft™ Windows Phone™ operating system, a Linux™ operating system or the like.

Further in accordance with various aspects of the disclosure, the methods described herein are intended for operation with dedicated hardware implementations including, but not limited to, PCs, PDAs, semiconductors, application specific integrated circuits (ASIC), programmable logic arrays, cloud computing devices, and other hardware devices constructed to implement the methods described herein.

It should also be noted that the software implementations of the disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, the disclosure is considered to include a tangible storage medium or distribution medium, as listed herein and including art-recognized equivalents and successor media, in which the software implementations herein are stored.

Aspects of the disclosure may be web-based. For example, a server may operate a web application in conjunction with a database. The web application may be hosted in a browser-controlled environment (e.g., a Java applet and/or the like), coded in a browser-supported language (e.g., JavaScript combined with a browser-rendered markup language (e.g., Hyper Text Markup Language (HTML) and/or the like)) and/or the like such that any computer running a common web browser (e.g., Internet Explorer™, Firefox™, Chrome™, Safari™ or the like) may render the application executable. A web-based service may be more beneficial due to the ubiquity of web browsers and the convenience of using a web browser as a client (i.e., thin client). Further, with inherent support for cross-platform compatibility, the web application may be maintained and updated without distributing and installing software on each.

Additionally, the various aspects of the disclosure may be implemented in a non-generic computer implementation. Moreover, the various aspects of the disclosure set forth herein improve the functioning of the system as is apparent from the disclosure hereof. Furthermore, the various aspects of the disclosure involve computer hardware that it specifically programmed to solve the complex problem addressed by the disclosure. Accordingly, the various aspects of the disclosure improve the functioning of the system overall in its specific implementation to perform the process set forth by the disclosure and as defined by the claims.

Aspects of the disclosure may include a server executing an instance of an application or software configured to accept requests from a client and giving responses accordingly. The server may run on any computer including dedicated computers. The computer may include at least one processing element, typically a central processing unit (CPU), and some form of memory. The processing element may carry out arithmetic and logic operations, and a sequencing and control unit may change the order of operations in response to stored information. The server may include peripheral devices that may allow information to be retrieved from an external source, and the result of operations saved and retrieved. The server may operate within a client-server architecture. The server may perform some tasks on behalf of clients. The clients may connect to the server through the network on a communication channel as defined herein. The server may use memory with error detection and correction, redundant disks, redundant power supplies and so on.

The application described in the disclosure may be implemented to execute on an Apple™ iOS™ operating system, a Google™ Android™ operating system, a RIM™ Blackberry™ operating system, a Nokia ™ Symbian™ operating system, a Microsoft™ Windows Mobile™ operating system, a Microsoft™ Windows Phone™ operating system, a Linux™ operating system or the like. The application may be displayed as an icon. The application may have been downloaded from the Internet, pre-installed, or the like. In some aspects, the application may be obtained from Google Play™, Android Market™, Apple Store™, or the like digital distribution source. The application may be written in conjunction with the software developers kit (SDK) associated with an Apple™ iOS™ operating system, a Google™ Android™ operating system, a RIM™ Blackberry™ operating system, a Nokia ™ Symbian™ operating system, a Microsoft™ Windows Mobile™ operating system, a Microsoft™ Windows Phone™ operating system, a Linux™ operating system or the like.

According to an example, the global navigation satellite system (GNSS) may include a device and/or system that may estimate its location based, at least in part, on signals received from space vehicles (SVs). In particular, such a device and/or system may obtain “pseudorange” measurements including approximations of distances between associated SVs and a navigation satellite receiver. In a particular example, such a pseudorange may be determined at a receiver that is capable of processing signals from one or more SVs as part of a Satellite Positioning System (SPS). Such an SPS may comprise, for example, a Global Positioning System (GPS), Galileo, Glonass, to name a few, or any SPS developed in the future. To determine its location, a satellite navigation receiver may obtain pseudorange measurements to three or more satellites as well as their positions at time of transmitting. Knowing the SV orbital parameters, these positions can be calculated for any point in time. A pseudorange measurement may then be determined based, at least in part, on the time a signal travels from an SV to the receiver, multiplied by the speed of light. While techniques described herein may be provided as implementations of location determination in GPS and/or Galileo types of SPS as specific illustrations according to particular examples, it should be understood that these techniques may also apply to other types of SPS, and that claimed subject matter is not limited in this respect.

The term text message or SMS refers to “short message service” which is a text messaging service component of phone, web, or mobile communication systems. It uses standardized communications protocols to allow fixed line or mobile phone devices to exchange short text messages. SMS was originally designed as part of GSM, but is now available on a wide range of networks, including 3G, 4G, LTE, 5G networks or networks associated with the communication channel as defined herein. In other aspects, text message may include Multimedia Messaging Service (MMS), which is a standard way to send messages that include multimedia content to and from mobile phones. It extends the core SMS (Short Message Service) capability that allowed exchange of text messages only up to 160 characters in length. While the most popular use is to send photographs from camera-equipped handsets, it is also used as a method of delivering news and entertainment content including videos, pictures, text pages and ringtones. MMS can be used within the context of the present invention for UICC activation message delivery. Of note is that MMS messages are delivered in a completely different way from SMS. The first step is for the sending device to encode the multimedia content in a fashion similar to sending a MIME e-mail (MIME content formats are defined in the MMS Message Encapsulation specification). The message is then forwarded to the carrier's MMS store and forward server, known as the MMSC (Multimedia Messaging Service Centre). If the receiver is on another carrier, the relay forwards the message to the recipient's carrier using the Internet.

The term voice or voice calls as utilized herein may include voice calls defined by 3GPP (3rd Generation Partnership Project) with Voice Call Continuity (VCC) specifications in order to describe how a voice call can be persisted, as a mobile phone moves between circuit switched and packet switched radio domains (3GPP TS 23.206).

The term data as utilized herein includes mobile broadband or wireless Internet access delivered through mobile phone towers over a communication channel as defined herein to computers, mobile phones, wireless devices, and other digital devices as defined herein using portable modems. Some mobile services allow more than one device to be connected to the Internet using a single cellular connection using a process called tethering.

As used herein interactive voice response (IVR) is a technology that allows a computer to interact with humans through the use of voice and DTMF tones input via keypad. In telecommunications, IVR allows customers to interact with a company's host system via a telephone keypad or by voice recognition, after which they can service their own inquiries by following the IVR dialogue. IVR systems can respond with prerecorded or dynamically generated audio to further direct users on how to proceed. IVR applications can be used to control almost any function where the interface can be broken down into a series of simple interactions. IVR systems deployed in the network are sized to handle large call volumes.

Voice recognition software may be utilized in various aspects of the systems and methods. Users may be able to vocalize, rather than utilizing other input processes. For example, the voice recognition software may be configured for generating text from voice input from a microphone or other voice input. A speech signal processor may convert speech signals into digital data that can be processed by the processor. The processor may perform several distinct functions, including serving as the speech event analyzer, the dictation event subsystem, the text event subsystem, and the executor of the application program. The speech signal processor may generate speech event data and transmit this data to the processor to be processed first by the speech event analyzer. The speech event analyzer may generate a list or set of possible candidates among the system recordings that represent or match the voice input processed by the speech signal processor. The speech event analyzer may transmit the candidate sets to a dictation event subsystem. The dictation event subsystem may analyze the candidate sets and choose the best match candidate with the highest degree of similarity. This candidate is then considered the correct translation, and the dictation event subsystem forwards the translation to the text event subsystem which in turn inputs the translated text into the device.

While the disclosure has been described in terms of exemplary aspects, those skilled in the art will recognize that the disclosure can be practiced with modifications in the spirit and scope of the appended claims. These examples given above are merely illustrative and are not meant to be an exhaustive list of all possible designs, aspects, applications or modifications of the disclosure.

What is claimed is:

1. A method for international roaming comprising:
storing in a non-transitory memory an international roaming application;
configuring a SIM (Subscriber Identity Module) to store identification information for accessing a first wireless network;
configuring a Soft SIM stored in the non-transitory memory to store identification information for accessing a second wireless network;
displaying on a display a user interface having a prompt to input information in response to the international roaming application;
wirelessly communicating with a transceiver with one of the following: the first wireless network and the second wireless network;
executing with a processor, operatively coupled to the non-transitory memory and the display, the international roaming application; and
implementing with the processor either the SIM in response to the international roaming application to access the first wireless network or the Soft SIM in response to the international roaming application to access the second wireless network.

2. The method according to claim 1, further comprising implementing with the processor the Soft SIM in response to the international roaming application to access the second wireless network, the processor providing information to the second wireless network from a SIM profile of the Soft SIM.

3. The method according to claim 1, wherein:
implementing with the processor the Soft SIM when the international roaming application is enabled to access the second wireless network, the processor providing information to the second wireless network from a SIM profile of the Soft SIM; and
implementing with the processor the SIM when the international roaming application is disabled to access the first wireless network, the processor providing information to the first wireless network from a SIM profile of the SIM.

4. The method according to claim 1, wherein:
implementing with the processor the international roaming application to generate a graphical user interface on the display, wherein the graphical user interface receives an input of information regarding desired features of international wireless service; and
sending with the processor and transceiver the information to an international roaming system.

5. The method according to claim 4, wherein the desired features of international service comprise countries being visited and dates during which the countries will be visited.

6. The method according to claim 4, wherein:
receiving with the graphical user interface an input of payment information regarding the desired international wireless service; and
sending with the processor and transceiver the payment information to the international roaming system.

7. The method according to claim 4, further comprising displaying on the graphical user interface a temporary phone number for the second wireless network for the desired international wireless service that is received from the international roaming system.

8. The method according to claim 4, further comprising displaying on the graphical user interface a plurality of wireless service plans received from the international roaming system for selection by a user.

9. The method according to claim 4, wherein:
implementing with the processor the Soft SIM when the international roaming application is enabled to access the second wireless network, the processor providing information to the second wireless network from a SIM profile of the Soft SIM;
implementing with the processor the SIM when the international roaming application is disabled to access the first wireless network, the processor providing information to the first wireless network from a SIM profile of the SIM;
implementing with the processor the international roaming application to generate a graphical user interface on the display, wherein the graphical user interface is configured to receive an input of information regarding desired features of international wireless service; and
sending with the processor and transceiver the information to an international roaming system.

10. The method according to claim 9, wherein:
receiving with the graphical user interface an input of payment information regarding the desired international wireless service;
sending with the processor and transceiver the payment information to the international roaming system; and
providing with the graphical user interface a temporary phone number for the second wireless network for the desired international wireless service that is received from the international roaming system.

11. A wireless device configured to provide international roaming capability comprising:
a non-transitory memory configured to store instructions to implement an international roaming application;
a SIM (Subscriber Identity Module) configured to store identification information for accessing a first wireless network;
a Soft SIM stored in the non-transitory memory, the Soft SIM configured to store identification information for accessing a second wireless network;
a display configured to display a user interface having a prompt to input information in response to the international roaming application;
a transceiver configured to wirelessly communicate with one of the following: the first wireless network and the second wireless network;
a processor, operatively coupled to the non-transitory memory and the display, the processor configured to execute the international roaming application; and
the processor further configured to implement either the SIM in response to the international roaming application to access the first wireless network or the Soft SIM in response to the international roaming application to access the second wireless network.

12. The wireless device according to claim 11, wherein when the processor is further configured to implement the Soft SIM in response to the international roaming application to access the second wireless network, the processor is further configured to provide information to the second wireless network from a SIM profile of the Soft SIM.

13. The wireless device according to claim 11, wherein:
the processor is further configured to implement the Soft SIM when the international roaming application is enabled to access the second wireless network, the processor configured to provide information to the second wireless network from a SIM profile of the Soft SIM; and
the processor is further configured to implement the SIM when the international roaming application is disabled to access the first wireless network, the processor configured to provide information to the first wireless network from a SIM profile of the SIM.

14. The wireless device according to claim 11, wherein:
the processor is further configured to implement the international roaming application to generate a graphical user interface on the display, wherein the graphical user interface is configured to receive an input of information regarding desired features of international wireless service; and
the processor and transceiver are configured to send the information to an international roaming system.

15. The wireless device according to claim 14, wherein the desired features of international service comprise countries being visited and dates during which the countries will be visited.

16. The wireless device according to claim 14, wherein:
the graphical user interface is further configured to receive an input of payment information regarding the desired international wireless service; and
the processor and transceiver are further configured to send the payment information to the international roaming system.

17. The wireless device according to claim 14, wherein the graphical user interface is further configured to provide a temporary phone number for the second wireless network for the desired international wireless service that is received from the international roaming system.

18. The wireless device according to claim 14, wherein the graphical user interface is further configured to display a plurality of wireless service plans received from the international roaming system for selection by a user.

19. The wireless device according to claim 14, wherein:
the processor is further configured to implement the Soft SIM when the international roaming application is enabled to access the second wireless network, the processor configured to provide information to the second wireless network from a SIM profile of the Soft SIM;
the processor is further configured to implement the SIM when the international roaming application is disabled to access the first wireless network, the processor configured to provide information to the first wireless network from a SIM profile of the SIM;
the processor is further configured to implement the international roaming application to generate a graphical user interface on the display, wherein the graphical user interface is configured to receive an input of information regarding desired features of international wireless service; and
the processor and transceiver are further configured to send the information to an international roaming system.

20. The wireless device according to claim 19, wherein:
the graphical user interface is further configured to receive an input of payment information regarding the desired international wireless service;
the processor and transceiver are further configured to send the payment information to the international roaming system; and
the graphical user interface is further configured to provide a temporary phone number for the second wireless network for the desired international wireless service that is received from the international roaming system.
